(19) United States
(12) Patent Application Publication
(10) Pub. No.: US 2006/0144862 A1
(43) Pub. Date: Jul. 6, 2006

(54) Lightweight, portable, collapsible, pressurized fluid delivery system for on demand use by hikers, runners, bikers, or other applications where periodic hydration is necessary

(76) Inventors: Lucas Reichert, Lehi, UT (US); Gabriel Reichert, Lehi, UT (US)

Correspondence Address: Lucas Reichert, 3636 Bay Cir, Lehi, UT, 84043, US

(21) Appl. No.: 11/026,224

(22) Filed: Jan. 3, 2005

(51) Int. Cl. A47J 36/08; A45F 3/16; B67D 5/64

(52) U.S. Cl. 222/175; 222/467; 224/148.2

(57) ABSTRACT

A system which applies pressure to a flexible, collapsible container of liquid stored within a flexible backpack. The system has an inflatable bladder of similar size and shape as the collapsible container of water upon which pressure is to be exerted. A tube permanently attached to the fluid container, having a valve at the opposite end for release of pressurized fluid when opened. A valve mechanism which can be opened by squeezing with the teeth when positioned in the user's mouth, or by digital pressure when held on the hand. A tube of permanently attached to the inflatable bladder through which air or other gas may pass providing means to inflate the bladder. The tubes being of sufficient length to extend beyond the confines of the backpack containing the liquid chambers extending to with easy reach of the person wearing the backpack. A stopcock or other valve connection providing means to control airflow into and out of the inflatable bladder. A pressure ball which provides means of forcing air into the bladder by repeated hand pressure on the ball.

### STATEMENT REGARDING FEDERALLY SPONSORED RESEARCH OR DEVELOPMENT

Not Applicable

### BACKGROUND OF INVENTION

Collapsible fluid delivery systems exist for use by hikers, runners, and bicyclists, where constant hydration of the body is extremely important. These hydration delivery systems consist of a collapsible fluid container held within a flexible back pack that is removable secured between the shoulders of the user. A mouthpiece, configured to be held in the mouth of the user, is connected to the container by a length of flexible tubing. The mouthpiece is comprised of a valve device within a chamber that normally prevents flow of liquid. When compressed by the teeth, the spring-biased valve within the mouthpiece chamber opens, allowing flow of liquid from the container into the mouth.

U.S. Pat. No. 5,060,833 addresses the concept of a collapsible water container within a flexible backpack. This proposal includes the valve within a mouthpiece attached to the container by a length of tubing. However, this proposal depends on hydrostatic head to move fluid from the container through the tube and mouthpiece. Use of this proposed device generally requires a considerable amount of suction to provide adequate flow of fluid to the user.

There are other portable fluid dispensing proposals such as a system for golf bags and stadium sporting event portable dispensing units. These systems use rigid pressure vessels to force liquids from the container through various types of conduits to the dispensing head. A pumping device is also included with in the scope of these proposals, so that the fluid containment vessel can be pressurized by hand. Examples of these proposals are cited in U.S. Pat. Nos. 5,564,605, and 4,921,143. Both of these proposals involve pressurization of a rigid fluid container.

There are several proposals for a portable spray mist, cooling device, which can be carried by the user in waste band pack. These proposals couple a spray nozzle to a rigid pressure chamber by a length of flexible tubing. These proposals also include a means of pressurizing the water container by means of a hand pump, or pressurization of the water chamber by filling of the water chamber located adjacent to separate chamber within the rigid pressure vessel that has been pre-charged with some sort of gas. Examples of these proposals are cited in U.S. Pat. Nos. 5,535,951, 5,622,056, 5,775,590, and 5,620,140.

Although one of these mechanisms provides for a collapsible fluid container, and others provide for pressurization of rigid vessels, which also contain the liquid to be dispensed, they do not provide a flexible means of applying pressure to a collapsible container held within a backpack. The need therefore, remains for a simple, lightweight, flexible means of applying pressure to a portable, collapsible fluid container that is held within a backpack or similar flexile carrying device

### BRIEF SUMMARY OF INVENTION

This invention resides in a system, which applies pressure to a collapsible container of water or other liquid.

Broadly, the invention assumes the form of a system of generally rectangular bladders, one of which can be filled with fluid, which is intended to be compressed, and the other which is intended to be filled with pressurized gas. The system of bladders can either be permanently joined together by means of a dividing membrane between two bladder cells, or two completely separate bladders placed next to each other during use. When empty, the system of bladders can be positioned within a flexible backpack in such a way as to exert uniform pressure on the fluid chamber when the pressure bladder is inflated.

The system preferably includes a collapsible container of water or other fluid stored within a flexible backpack that is removably secured between the shoulders of the user. A flexible tube extends from the bag to a valve device, which can be opened by exerting pressure on the sidewalls thereof, allowing pressurized fluid to escape from the system. When hydration is desired, pressure may be exerted by the teeth, when holding the valve mechanism in the mouth. Pressure can also be exerted on the valve sidewalls with digital pressure to provide a pressurized shower effect for the user.

The system preferably further includes a means of variably pressurizing the pliable compression chamber with oxygen or ambient air. Air or oxygen can be introduced into the flexible pressure vessel through a length of tubing permanently attached to the pressure chamber at one end and having appropriate connectivity at the other end. The tubing is sufficient length to extend out of the flexible backpack, which carries the collapsible fluid vessel, making the connection end thereof readily accessible to the user.

Either a cylinder of compressed oxygen, when using this media as a pressurization means, or a simple hand pump, in the case of ambient air usage as a pressure medium, can be attached to the connectivity end of the length of tubing by means of a luer connector or other means of connection and disconnection.

After inflation of the pressure chamber using a cylinder of compressed oxygen, a stopcock, or other valve mechanism attached to the connection end of the tube can be closed to prevent oxygen from escaping the flexible pressure chamber upon disconnection of the oxygen cylinder. The stopcock can be opened, releasing the pressure, should deflation be desired.

The hand pump system is preferably comprised of a squeeze ball, which contains valves in sequence, such that when squeezed by hand, air inside the ball is forced through the tube into the pressure chamber. Upon release of hand pressure, the bulb once again returns to its original shape, filling with ambient air. Repeated squeezing of the bulb enables a pumping action to fill the pressure chamber to the desired level.

The connection end of the tube preferably includes a means of securement to the shoulder backpack strap on either side of the pack at the option on the user.

### BRIEF DESCRIPTION OF THE DRAWINGS

FIG. 1 is a drawing that shows, from the side view perspective, the flexible pressurization chamber system when being used in combination with a flexible fluid chamber within a flexible backpack according to the embodiment of the invention.

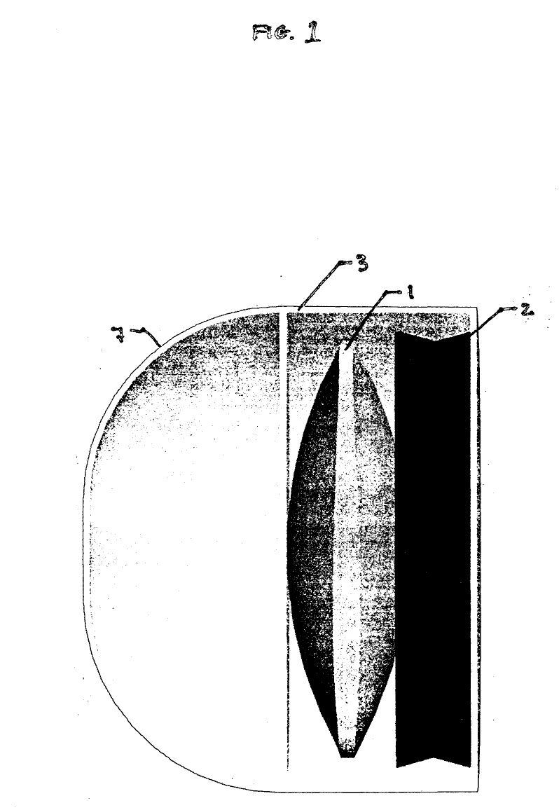

FIG. 2 is a drawing that shows, from the front view perspective, a connection means for ease of connection of a oxygen or air cylinder to the flexible pressure chamber fill tube according to the embodiment of the invention.

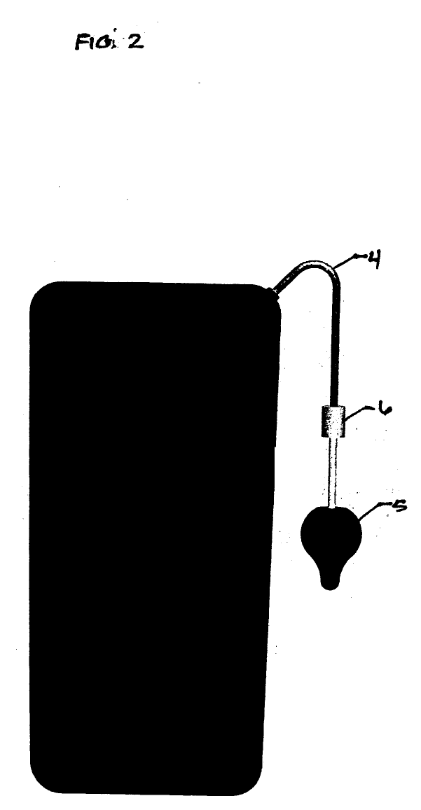

FIG. 3 is a drawing that shows from the front view perspective, a flexible pressure chamber according to the attached fill tube and pressurization bulb embodiment of the invention.

### DETAILED DESCRIPTION OF THE INVENTION

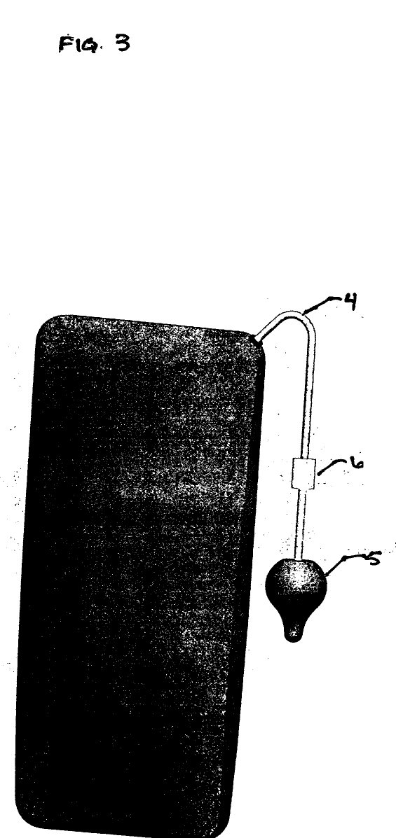

Broadly this invention provides system of applying pressure to a collapsible container of water stored within a flexible backpack as depicted in FIG. 3. The pressure application system consists of an inflatable bladder 1, which can be positioned next to collapsible fluid container 2, held with flexible backpack 3.

The system is further comprised of tube 4 of sufficient length to extend beyond the confines of backpack 3 so as to be able to extend all the way to the mouth when the backpack is in position on a person's back.

The preferred embodiment of the system provides means of pressurizing the inflatable bladder by means of an inflation ball 5 attached to the distal end of the tube 4 by means of stopcock connector 6. The pressurization ball can be readily disconnected from tube 4 for ease of assembly of within the backpack. The stopcock 6 may be rotated to the closed position to prevent air escaping from the inflated bladder 1, if the pressurization ball 5 is removed. The stopcock 6 also provides for a means of allowing controlled pressure reduction of complete deflation of the bladder 1, as desired.

An oxygen container or other pressurized gas cylinder can also be connected to tube 4 by means of connector 6.

Tube 4 may be attached of backpack shoulder straps 7 by means of clip 8 to prevent undesired movement of pressurization system during vigorous exercise.

We claim:

1. A system of applying pressure to a collapsible liquid container held within a flexible backpack, comprising;
A collapsible fluid container held within a flexible backpack poisoned between the shoulders of the user;
A length of flexible tube connected to the fluid container, having a valve at the opposite end;
A valve positioned at the proximal end of the tube, allowing escape of fluid when opened;
A separate inflatable bladder of similar size and shape as the collapsible liquid container upon pressure is to be exerted;
A tube permanently attached to the inflatable bladder providing means of inflation and deflation;
Such tube being of sufficient length to extend beyond the confines of the backpack to with reach of the user;
A stopcock or other valve mechanism permanently attached to the proximal end of the tube allowing detachable connection of various pressurization means such as pressure ball, CO2, compressed air cylinder, or oxygen tank;
A preferred pressurization means comprised of a pressure ball disconnect ably attached to the proximal end of the tube.

2. A collapsible, pressurized fluid delivery system of claim 1, further including a compartmentalized bladder configuration comprising:
A single bladder with two separate compartments, one for fluid, and one for pressurizing gas;
A tube attached to the fluid compartment with a valve at the end for release of fluid when opened;
A tube attached to the gas compartment with connected hand pressure pumping device.

3. A collapsible, pressurized fluid delivery system of claim 1 further including a bifurcated flexible tube configuration comprising:
A single bifurcated flexible tube;
One lumen being permanently attached to the collapsible fluid bladder;
A second lumen being permanently attached to the gas pressurization bladder.

4. A collapsible, pressurized fluid delivery system of claim 2 further including a bifurcated flexible tube configuration comprising:
A single bifurcated flexible tube;
One lumen being permanently attached to the collapsible fluid bladder;
A second lumen being permanently attached to the gas pressurization bladder.

5. A collapsible, pressurized fluid delivery system consisting of a single flexible bladder held within a flexible backpack which can be pressurized by means as in claim 1.
